(19) United States
(12) Patent Application Publication
(10) Pub. No.: US 2024/0308371 A1
(43) Pub. Date: Sep. 19, 2024

(54) Solar Shield 6

(71) Applicant: Marcus Henry Welles, Hampton, GA (US)

(72) Inventor: Marcus Henry Welles, Hampton, GA (US)

(21) Appl. No.: 18/122,424

(22) Filed: Mar. 16, 2023

(51) Int. Cl. B60L 53/51; B60K 16/00; B60L 8/00

(52) U.S. Cl. CPC B60L 53/51; B60K 16/00; B60L 8/003; B60K 2016/003; B60K 35/60; B60K 2360/23; B60K 2360/785

(57) ABSTRACT

A system for charging electric vehicles with solar panels inside the car. Making it possible to charge your vehicle any where while the sun is up. Eliminating some of the expense of charging the electric vehicle, and looking for charging stations. The solar system can power your house when the power goes out. While at work your car can be charging and when you get off work you car is charged. Plug into the sun.

### BACKGROUND OF THE INVENTION

Using the off grid system of solar power with the combination of solar panels, sewing, magnets, and custom design. This enables you to take the solar system with you on the road; adding cooling and comfort to the privacy of your car.

Solar Shield 6 is a combination of, reflective material for the foundation that is custom fitted to each window of a car. Next the magnets are encased with twill tape and machine sewn. Then the solar panels are attached to reflective material with sewing. This is what allows the Solar Shield 6 to snap to the steel in the car.

As the solar panels collects the sunlight they create electricity and pass the electricity through a converter to a solar charging system which I developed. Enabling charging the electric vehicle, any where you go.

### BRIEF SUMMARY OF THE INVENTION

Solar Shields 6 will make charging your Electric Vehicle free after you make the purchase. The shortage of Electric Vehicle charger station will be a thing of the pass. You will be able to charge your EV anywhere.

### BRIEF DESCRIPTION OF THE DRAWING FIGURES

FIG. 1 is a perspective view of a car with the Solar Shields installed with and electric vehicle charging core plugged in according to an embodiment of the present invention.

FIG. 2 is an interior view of the driver side of the car. The front and rear solar shields installed with the wiring and components according to an embodiment of the present invention.

FIG. 3 is a top view of the wiring and components according to an embodiment of the present invention.

FIG. 4 is Solar Shield 4 for the front window shield, the flexible panels makes the panels easy to bend and install according to and embodiment of the present invention.

FIG. 5 is Solar Shield 5 for the front passenger window, the solar shield snaps to the steel in the car and sits on the door, so the door carries the weight, according to an embodiment of the present invention.

FIG. 6 is Solar Shield 6 for the rear window passenger side of the EV, the converter is on the back side of this solar panel, some panels have the converter on the front side, according to an embodiment of the present invention.

FIG. 7 shows the insertion of the magnets between the reflective material and the twill tape. The magnets are sewn on four sides for precise placement, according to an embodiment of the present invention.

FIG. 8 is the back window Solar Shield 8 with the support leg, that holds the panel up on an angle to catch the sunlight, and folds down when you need it to lie flat according to an embodiment of the present invention.

FIG. 9 is a electric vehicle charging cable according to an embodiment of the present invention.

FIG. 10 is a flow chart of the main components according to an embodiment of the present invention.

FIG. 11 is a front view of the solar charging system according to an embodiment of the present invention.

### DETAILED DESCRIPTION

### Solar Shield 6

### System for Powering Electric Vehicles With Solar Power

The inventor provides a unique system for charging electric vehicles with solar panels inside the vehicle. This mobile charging system can be installed when the car is parked. The solar panel are sewn to a reflective material that is constructed to hold the solar panels against the car window and absorb the sunlight to the PV cells in the panel. This energy creates electrical charges that move in response to an internal electrical field in the cell causing electricity to flow. The present invention is described in enabling detail in the following examples, which may represent more than one embodiment of the present invention.

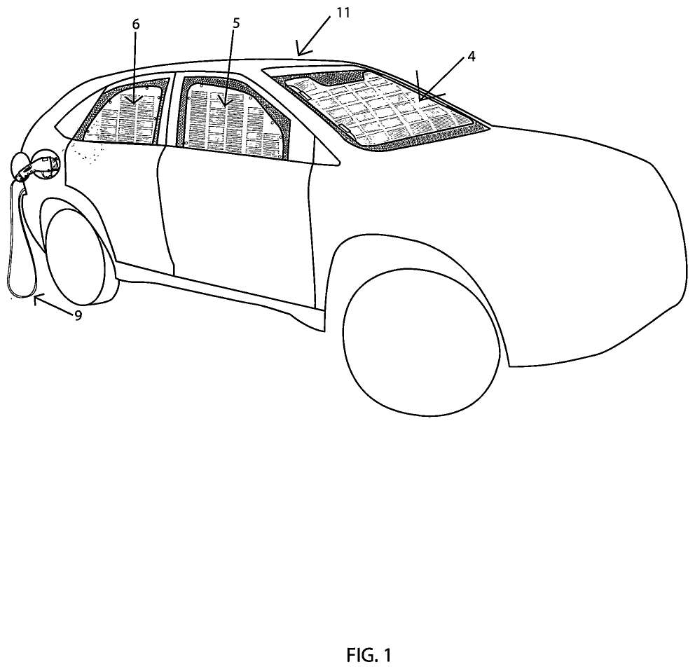

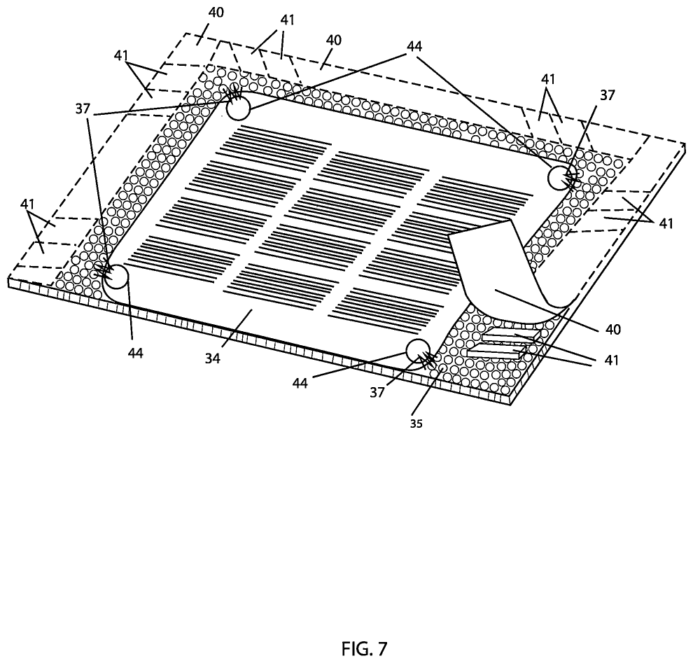

FIG. 1 is a perspective view of a car 11 with a front window Solar Shield panel 4 installed in the car 11, attached to the sun visor hooks 45, according to an embodiment of the present invention. In one embodiment a Solar Shield 5 is installed in the car 11, and supported by magnets 41 according to an embodiment of the present invention. Car 11 in this example has a Solar Shield 6 in the passenger back window, held up by magnets 41. As illustrated in FIG. 7, according to an embodiment of the present invention.

According to an embodiment of the present invention, Car 11 in this example has a electric vehicle charging cable 9 charging the car.

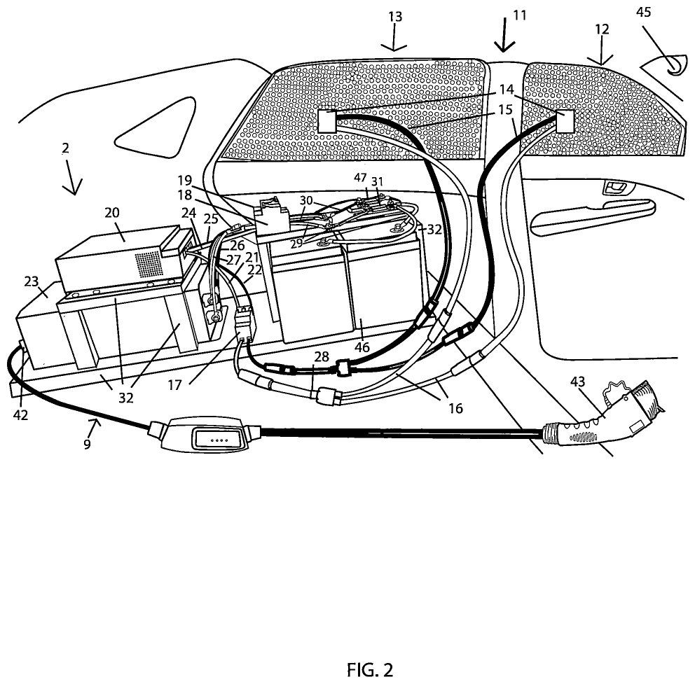

FIG. 2 is inside the car 11 view with the front driver window, a Solar Shield 12 installed and held up to the window with magnets 41 as shown in FIG. 7, according to an embodiment of the present invention. When operating, in one embodiment a electric energy converter 14 is charging the negative wire 15 and positive wire 16 and feeding a solar charging system 2 through a circuit breaker 17. Car 11 back driver side window in this example, is a Solar Shield 13 installed and held up to the window with magnet 41 to the steel in the car 11 according to an embodiment of the present invention. Car 11 in this example has a solar charging system 2 that takes the 12 volts DC from the Solar Shields and converts it to 220 volts AC and power a electric vehicle charging cable 9, that plugs into a inverter 23 with a plug 42 that charges the car 11 with a plug 43.

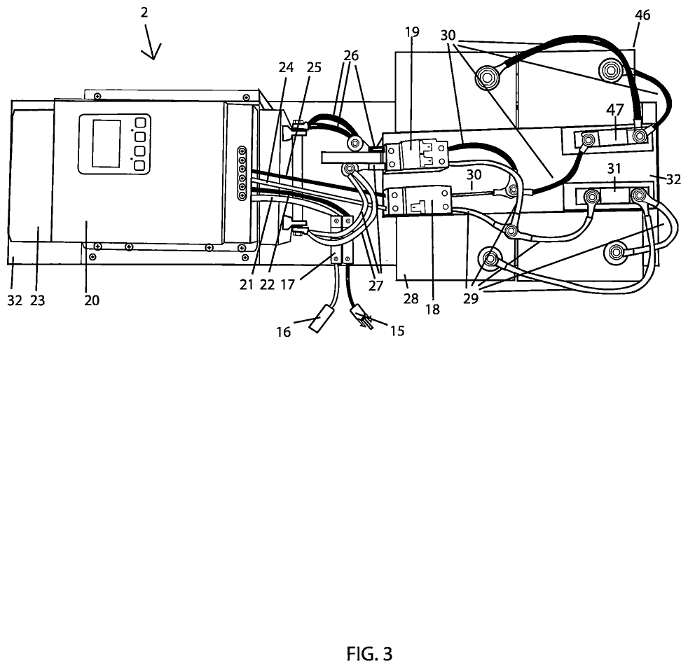

FIG. 3 is a top view of the solar charging system 2 with the wiring and components in this example, a circuit breaker 17 is where the 12 volts DC electricity enters the solar charging system 2 from the Solar Shields, 4, 5, 6, 8, 12 and 13, moving through wire 21 positive and wire 22 negative to a charge controller 20 that manages the electricity.

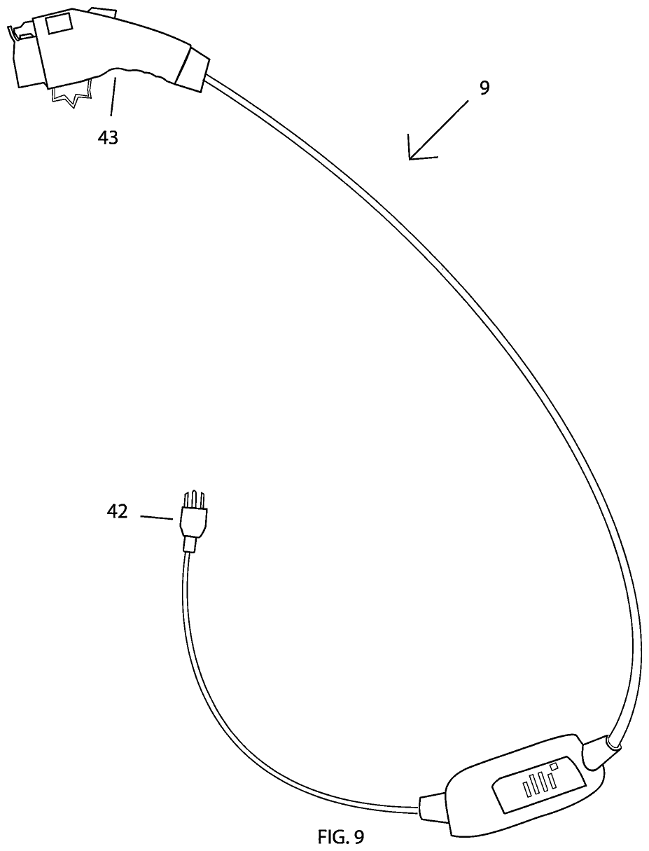

Charge controller 20 sends the electricity out wire 24 positive and wire 25 negative to a circuit breaker 18 to charge a battery 46. Wire 29 positive leaves a circuit breaker 18 to charge a battery 28, and branches off to a circuit breaker 19 and fuse 31. Wire 30 negative leaves circuit breaker 18 and charges the battery 46, and branches off to circuit breaker 19 and fuse 47. When in operation in one embodiment circuit breaker 19 is the on and off switch for the electricity moving to a inverter 23. Circuit breaker 19 feeds electricity through wires 26 negative to the inverter. Circuit breaker 19 feeds electricity through wires 27 positive to the inverter. The inverter 23 takes the electricity it receives and converts the 12 volts DC to 220 volts AC according to an embodiment of the present invention. In this example a electric vehicle charging cable 9 in FIG. 9 plugs into the inverter 23, and plugs into the car 11 in FIG. 1 according to an embodiment of the present invention. The solar charging system 2 is constructed on a wooden frame 32 in this example.

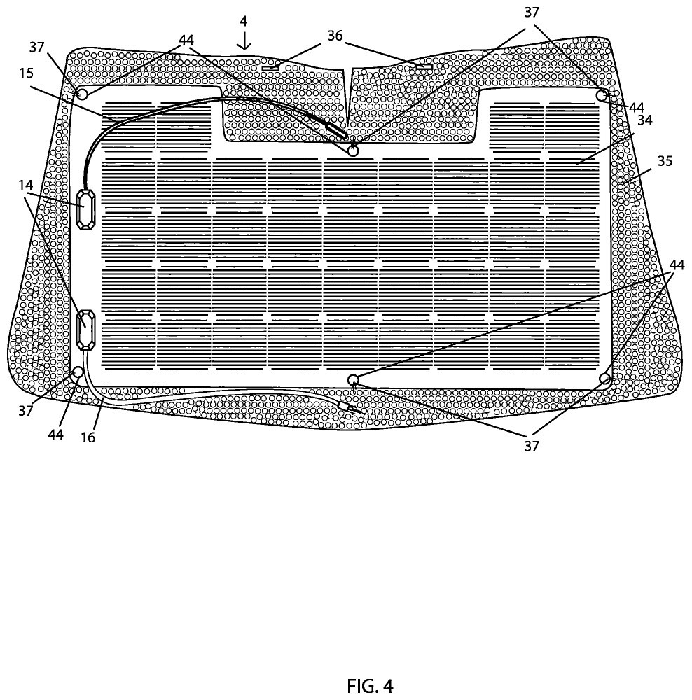

FIG. 4 In this example a front window Solar Shield 4 consist of reflective material 35, a solar panel 34, and is attached to the reflective material with stitching 37 to the eyelets 44. When in operation in one embodiment the solar panel 34 converts electricity, with a converter 14 sending electricity to a negative wire 15 and a positive wire 16 to a circuit breaker 17 of the solar charging system 2.

In this example the Solar Shield 4 is supported through a opening 36 that a hooks 45 passes through to holds the Solar Shield 4 in place.

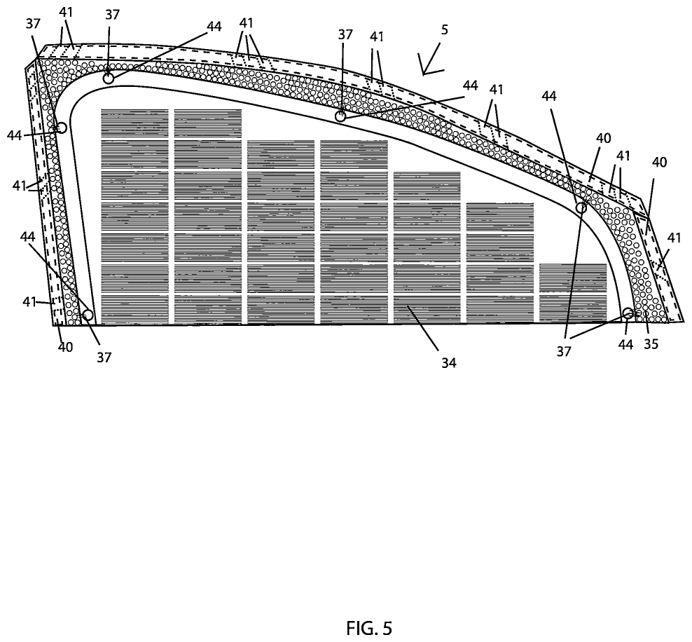

FIG. 5 in this example, a passenger front window Solar Shield 5 is constructed, with reflective material 35 as the base for the solar panel 34, that is attached with stitching 37 through eyelets 44 to the reflective material 35. In one embodiment a twill tape 40 is sewn to the reflective material 35 that encases the magnets 41 to the reflective material 35 that snaps the Solar Shield 5 to the steel in the car 11 pressing the Solar Shield 5 against the window collecting sunlight to create electricity, according to an embodiment of the present invention.

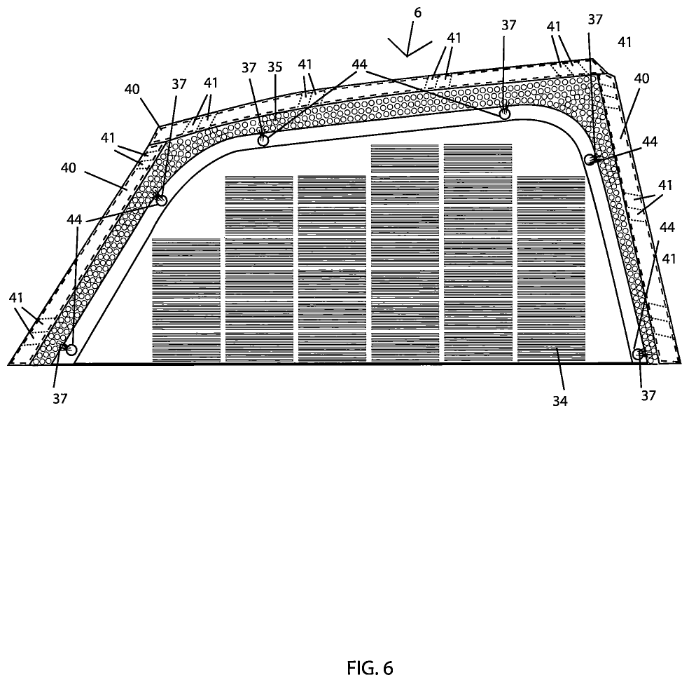

FIG. 6 in this example, a passenger back window Solar Shield 6 is constructed, with reflective material 35 as the base for the solar panel 34, that is attached with stitching 37 through eyelets 44 to the reflective material 35. The twill tape 40 is sewn to the reflective material 35 that encases the magnets 41 to the reflective material 35 that snaps the Solar Shield 6 to the steel in the car 11 pressing the Solar Shield 6 against the window collecting sunlight to create electricity, according to an embodiment of the present invention.

FIG. 7 in this example, shows the insertion of the magnets 41 between the reflective material 35 and the twill tape 40. The twill tape 40 is sewn on 4 sides and then diagonal stitched to give the magnets 41 precise placement along three sides of the Solar Shields, top, left and right sides In this example the solar panel 34 is attached to the reflective material 35 with stitching 37 through the eyelets 44. The Solar Shields are fitted to each car 11 to ensure the best fit for each customer. This solar panels 34 has the convert 14 on the back side, the placement depending on the manufacturer. The reflective material 35 while holding the solar panels 34, also block the sun from over heat your car 11 and adds privacy according to an embodiment of the present invention.

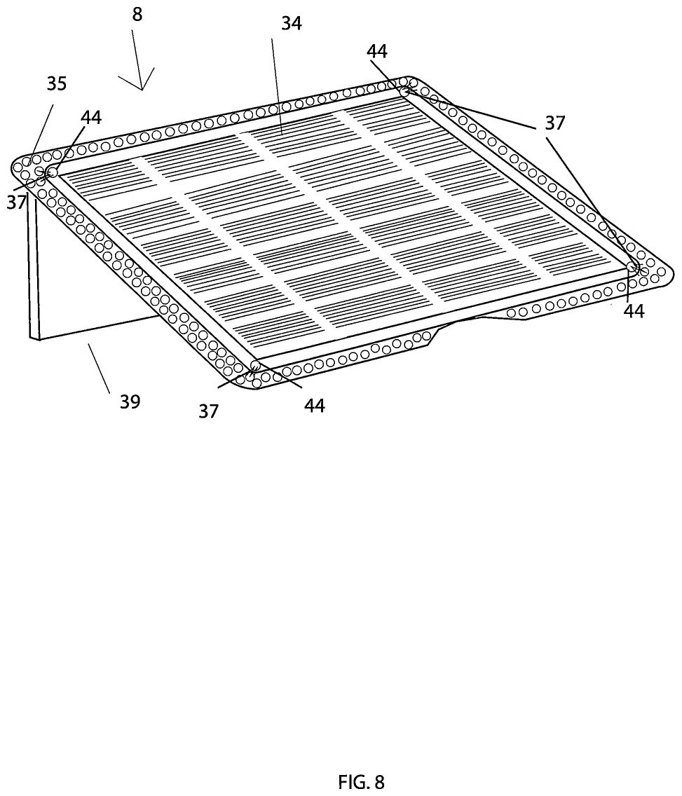

FIG. 8 is a perspective view of the back window, a Solar Shield 8 according to an embodiment of the present invention. Solar Shield 8 has a solar panel support 39 attached at stitching 37 top to angle the solar panel 34 up to the sun. When not is use the solar panel support 39 folds down flat and out of the way. In this example the reflective material 35 is the base for the solar panel 34 that is attached with stitching 37 through the eyelet 44.

FIG. 9 in this example 9 is a electric vehicle charging cable, that plugs into the inverter 23 with plug 42 and plug 43 plugs into the car 11 according to an embodiment of the present invention.

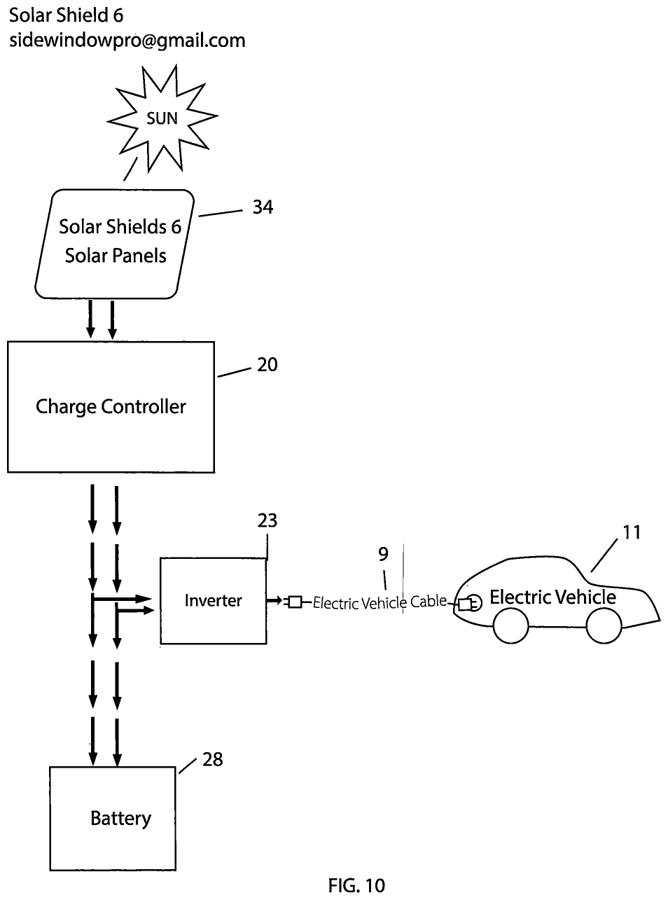

FIG. 10 is a process flow chart illustrating electronic components of the Solar Shield 6 according to another embodiment of the present.

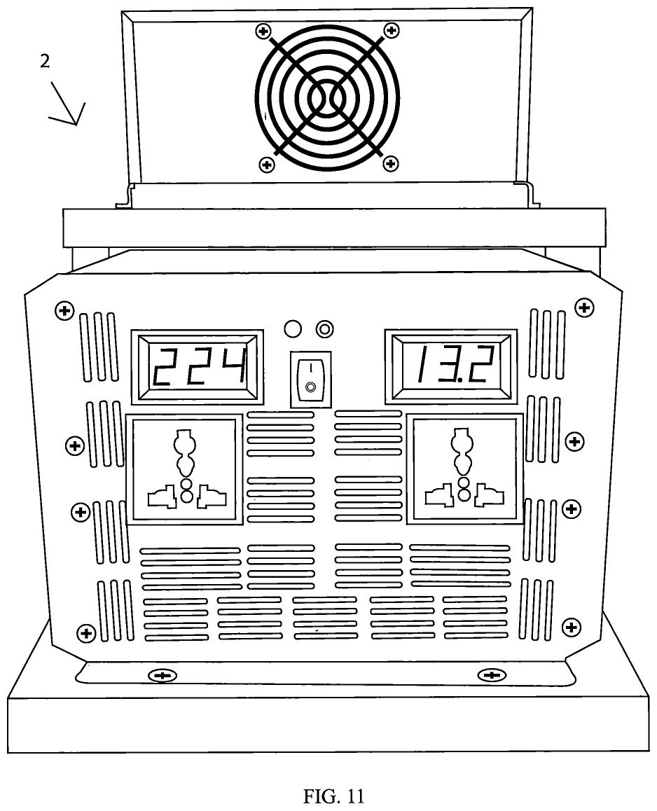

FIG. 11 in this example is a front view of 2 according to an embodiment of the present invention.

It will be apparent to one with skill in the art that the Solar Shield 6 invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

What is claimed is:

1. A system for charging Electric Vehicles with sun light that shines onto a solar panel, the sun light is absorbed by the PV cells in the panel. This energy creates electrical charges that move in response to an internal electrical field in the cell causing electricity to flow, comprising:
a solar panel passes the electricity through a converter to a positive and negative wire, that is wired to a charge controller;
an charge controller accepts the electricity into the inputs for the positive and negative solar panel feed into the charge controller, and manages the electricity for distribution to other components.
an battery bank is connected to the charge controller outputs, positive and negative out going wires feeding electricity to the batteries.
a inverter is connected to the positive and negative wires of the batteries and converts the DC 12 volts current to AC 220 volts;
an electric vehicle charging cable is plugged into the inverter:
an electric vehicle is then plugged into, by the electric vehicle charging cable, and the car is charging by solar power from the sun;

2. The system of claim 1 the solar panels are installed inside of the car.

3. The system of claim 1 the solar panels are attached to a reflective material that blocks the sun heat and adds privacy.

4. The system of claim 1 the reflective material is constructed to snap to the steel in the car with magnets that are sewn down with twill tape on the sides and top.

5. The system of claim 1 the front window reflective material has openings to connect to the sun visor hooks.

6. The system of claim 1 the back window reflective material has a support leg to hold the panel up on and angle to absorb sunlight. The support leg folds down and lay flat when needed.
